(19) United States
(12) Patent Application Publication
(10) Pub. No.: US 2026/0051727 A1
(43) Pub. Date: Feb. 19, 2026

(54) OVERVOLTAGE PROTECTOR WITH INTEGRATED FAILURE PROTECTION

(71) Applicant: Southwire Company, LLC, Carrollton, GA (US)

(72) Inventors: Donald Paul Oldham, Jr., Trinity, FL (US); Kyle Curry, Palm Harbor, FL (US)

(21) Appl. No.: 19/296,370

(22) Filed: Aug. 11, 2025

Related U.S. Application Data
(60) Provisional application No. 63/682,559, filed on Aug. 13, 2024.

(51) Int. Cl. H02H 3/02; H01H 37/76; H01H 85/02; H02H 1/00; H02H 3/20

(52) U.S. Cl. CPC H02H 3/023; H01H 37/767; H01H 85/0241; H02H 1/0007; H02H 3/20; H01H 2037/768; H01H 2085/0275

(57) ABSTRACT

An overvoltage protection apparatus with failure protection is provided. The overvoltage protection apparatus may include a first set of one or more overvoltage protection components connected between a powered line and a return line, a thermal switch in thermal communication with the first set of one or more overvoltage protection components, and an electromechanical switch coupled to the thermal switch. The electromechanical switch may be configured to trigger a circuit breaker for the powered line when actuated. When the thermal switch is exposed to a temperature corresponding to the heat generated by the at least one overvoltage protection component and the temperature exceeds a threshold temperature, the thermal switch may actuate the electromechanical switch to create a short circuit such that the short circuit triggers the circuit breaker to interrupt power supplied by the powered line.

### CROSS-REFERENCE TO RELATED APPLICATIONS

This application claims priority to U.S. Provisional Patent Application No. 63/682,559, filed on Aug. 13, 2024, which is incorporated herein by reference in its entirety.

### FIELD OF INVENTION

The present disclosure relates generally to overvoltage protectors such as surge protection devices. Example embodiments are directed to overvoltage protectors with integrated failure protection.

### BACKGROUND

Power systems for supplying power to electrical equipment (e.g., electronics, electrical installations, etc.) and/or to power distribution systems for delivering power to such electrical equipment, whether in residential buildings, commercial buildings, telecommunication systems, or the like, may experience excessive voltage due to a variety of reasons. For example, lightning strikes may cause excessive voltage in a power system for supplying power to a power distribution system and/or electrical equipment.

A surge protection device may be designed to protect electrical equipment against excessive voltage in the power system supplying power to the electrical equipment or supplying power to a power distribution system configured for delivering power to the electrical equipment. In particular, a surge protection device may include one or more overvoltage protection components configured to protect electrical equipment from excessive voltage. When these overvoltage protection components reach their end of life, they tend to fail-often in a volatile manner—from overcurrent, overheating, and/or explosion. Existing surge protection devices are generally designed to disconnect from the power system, for safety reasons, when they reach their end of life. However, by disconnecting from the power system, the electrical equipment is left unprotected from any excessive voltage that may result and lead to severe damage to the electrical equipment.

Through applied effort, ingenuity, and innovation, Applicant has solved problems related to surge protectors including, but not limited to, the above noted challenges and problems in existing surge protection devices.

### BRIEF SUMMARY

According to one aspect of the present disclosure an overvoltage protection apparatus with failure protection is provided. In various embodiments, the overvoltage protection apparatus includes a first set of one or more overvoltage protection components connected between a powered line and a return line, wherein at least one overvoltage protection component of the first set of one or more overvoltage protection components generates heat when at its end of life; a thermal switch in thermal communication with the first set of one or more overvoltage protection components; and a electromechanical switch coupled to the thermal switch and configured to trigger a circuit breaker for the powered line when actuated, wherein when the thermal switch is exposed to a temperature corresponding to the heat generated by the at least one overvoltage protection component and the temperature exceeds a threshold temperature, the thermal switch actuates the electromechanical switch to create a short circuit such that the short circuit triggers the circuit breaker to interrupt power supplied by the powered line.

In some example embodiments, the electromechanical switch comprises a latching relay.

In some example embodiments, the thermal switch is a normally open thermal switch configured to switch to a closed state when exposed to temperature that exceeds the threshold temperature.

In some example embodiments, the threshold temperature is less than 125° C.

In some example embodiments, the powered line and the return line are connected to a telecommunications power distribution system configured to supply power to electrical equipment including telecommunications electrical equipment located at a cell tower.

In some example embodiments, the circuit breaker is upstream relative to the cell tower.

In some example embodiments, the overvoltage protection further includes a second set of one or more overvoltage protection components connected between the return line and a ground, wherein the thermal switch is further in thermal communication with the second set of one or more overvoltage protection components.

In some example embodiments, the first set of one or more overvoltage protection components comprise a first set of one or more varistors and the second set of one or more overvoltage protection components comprise a second set of one or more varistors.

In some example embodiments, the thermal switch is exposed to a temperature that exceeds the threshold temperature when an overvoltage protection component of any of the first set of one or more overvoltage protection components or any of the second set of one or more overvoltage protection components fails at its end of life and generates heat corresponding to a temperature that exceeds the threshold temperature.

In some example embodiments, the first set of one or more overvoltage protection components, the second set of one or more overvoltage protection components, the thermal switch, and the electromechanical switch are formed and/or disposed on a circuit board.

In some example embodiments, the overvoltage protection further includes a protector housing configured to house one or more of (i) the first set of one or more overvoltage protection components, (ii) the second set of one or more overvoltage protection components, (iii) the thermal switch, or (iv) the electromechanical switch.

According to another aspect of the present disclosure an overvoltage protection apparatus with failure protection is provided. In various embodiments, the overvoltage protection apparatus includes a first set of one or more overvoltage protection components connected between a powered line and a return line, wherein at least one overvoltage protection component of the first set of one or more overvoltage protection components generates heat when at its end of life; a thermal sensor assembly in thermal communication with the first set of one or more overvoltage protection components; and a electromechanical switch coupled to the thermal sensor assembly and configured to trigger a circuit breaker for the powered line when actuated, wherein when the thermal sensor assembly is exposed to a temperature corresponding to the heat generated by the at least one overvoltage protection component and the temperature exceeds a threshold temperature, the thermal sensor assembly actuates the electromechanical switch to create a short circuit such that the short circuit triggers the circuit breaker to interrupt power supplied by the powered line.

In some example embodiments, the electromechanical switch comprises a latching relay.

In some example embodiments, the thermal sensor assembly comprises a circuit board having at least a pair of electrodes and a meltable component disposed thereon, and wherein the meltable component is configured to melt and flow across the pair of electrodes to form a current flow path between the pair of electrodes when the meltable component is exposed to a temperature that exceeds the threshold temperature.

In some example embodiments, the circuit board further comprises two normally open contacts, wherein the current flow path between the pair of electrodes causes the two normally open contacts to close to actuate the electromechanical switch.

In some example embodiments, the meltable component comprises a low temperature melting alloy.

In some example embodiments, the meltable component is disposed over the pair of electrodes with an insulator disposed between the meltable component and the pair of electrodes.

In some example embodiments, the overvoltage protection apparatus further includes a second set of one or more overvoltage protection components connected between the return line and a ground, wherein the thermal sensor assembly is further in thermal communication with the second set of one or more overvoltage protection components.

In some example embodiments, the first set of one or more overvoltage protection components comprise a first set of one or more varistors and the second set of one or more overvoltage protection components comprise a second set of one or more varistors.

In some example embodiments, the meltable component is exposed to a temperature that exceeds the threshold temperature when an overvoltage protection component of any of the first set of one or more overvoltage protection components or any of the second set of one or more overvoltage protection components fails at its end of life and generates heat corresponding to a temperature that exceeds the threshold temperature.

### BRIEF DESCRIPTION OF THE DRAWINGS

Reference will now be made to the drawings, which are not necessarily drawn to scale, and wherein:

FIG. 1 shows a schematic diagram of an overvoltage protection system in accordance with at least one embodiment of the present disclosure.

FIG. 2 shows a schematic diagram of an overvoltage protection apparatus in accordance with at least one embodiment of the present disclosure.

FIGS. 3A-C show at least a portion of an operational example of an overvoltage protection apparatus in accordance with at least one embodiment of the present disclosure.

FIG. 4A shows an operational example of a thermal sensor assembly in accordance with at least one embodiment of the present disclosure.

FIG. 4B shows an operational example of a thermal sensor assembly showing various components thereof in accordance with at least one embodiment of the present disclosure.

FIG. 5 shows at least a portion of an operational example of an overvoltage protection apparatus in accordance with at least one embodiment of the present disclosure.

FIG. 6 shows a schematic diagram of an overvoltage protection system in accordance with at least one embodiment of the present disclosure.

FIG. 7 shows a schematic diagram of an overvoltage protection apparatus in accordance with at least one embodiment of the present disclosure.

### DETAILED DESCRIPTION OF VARIOUS EMBODIMENTS

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. Like numbers refer to like elements throughout.

Various embodiments of the present disclosure are directed to an overvoltage protection system for detecting overvoltage condition (e.g., excessive voltage) in a power system configured for supplying power to electrical equipment and protecting the electrical equipment against the overvoltage condition. The power system may be a split-phase power system, a single-phase power system, a three-phase power system or any other power system. Additionally, according to various embodiments, the overvoltage protection system is configured to detect a failure condition associated with the overvoltage protection system and cause power supplied, by the power system, to the electrical distribution system to be interrupted in response to detecting the failure condition. In various embodiments, the failure condition is a device failure condition such as failure of an overvoltage protection component at its end of life.

According to various embodiments, the overvoltage protection system comprises an input power source comprising one or more powered conductor lines (e.g., one or more powered lines) and a return conductor line (which is often referred to as return line, grounded conductor line, or neutral line). The overvoltage protection system also comprises a protection module. The protection module is configured to protect electrical equipment against overvoltage condition in a power system supplying power to the electrical equipment. The protection module, for example, may be configured to function as a surge protector. The protection module includes one or more overvoltage protection components leveraged to protect electrical equipment from excessive voltage (e.g., overvoltage condition in the power system supplying power to the electrical equipment). In various embodiments, the one or more overvoltage protection components comprise one or more varistors. The one or more varistors may be of any of a plurality of varistor types. In various embodiments, the protection module includes one or more metal-oxide varistors (MOVs). Alternatively or additionally, in some embodiments, the one or more overvoltage protection components may comprise transient voltage suppression (TVS) diodes, Zener diodes, and/or inductors. In an example embodiment, the one or more overvoltage protection components comprise a TVS diode and inductor in parallel with at least one MOV.

Additionally, the protection module is configured to detect a failure condition associated with the one or more overvoltage protection component(s). The failure condition may occur at the end of life of the overvoltage protection components, such as end of life of a varistor. For example, overvoltage protection components such as varistors tend to generate and conduct heat when they reach their end of life. This, in turn, creates safety hazards and leaves electrical equipment unprotected. In this regard, the overvoltage protection system (e.g., protection module therein) is configured at least in part to protect against these safety hazards and to provide notification of a varistor failure, for example, by triggering (e.g., tripping) a power supply breaker of the power system.

In some embodiments, the overvoltage protection system may be configured to monitor current and/or voltage on one or more of a powered conductor line or return line to detect one or more fault conditions in the power system, such as, but not limited to open neutral condition. In some embodiments, the overvoltage protection system may include a controller configured to facilitate and/or perform various functions associated with the overvoltage protections system. For example, in embodiments, where the overvoltage protection system is configured to detect fault conditions such as open neural condition, the overvoltage protection system may include a controller configured to facilitate and/or perform various functions associated with detecting open neutral condition and/or other fault conditions and/or sending alarms or notifications to operators.

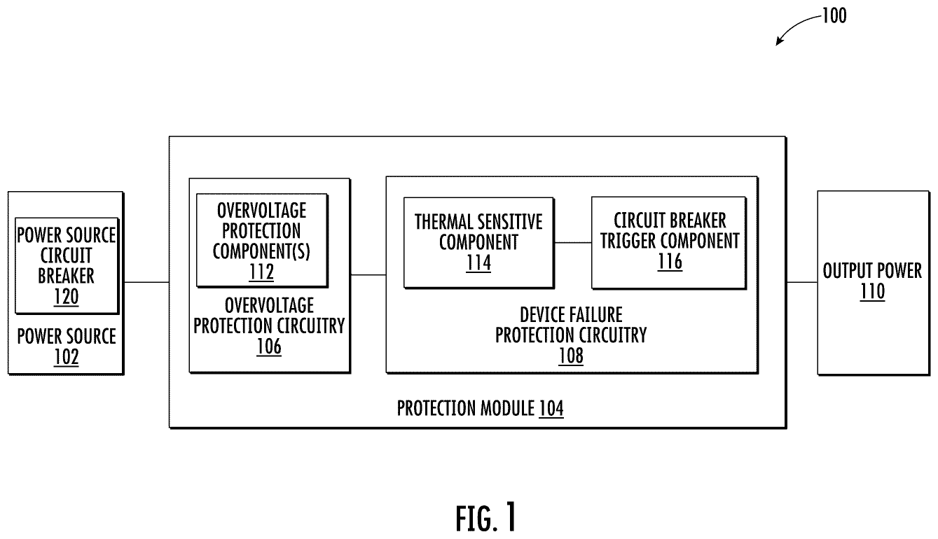

FIG. 1 shows a schematic diagram of an overvoltage protection system 100 in accordance with at least one embodiment of the present disclosure. In the illustrated embodiment of FIG. 1, the overvoltage protection system 100 includes a power source 102, a protection module 104, and an output power 110. The depiction of the overvoltage protection system 100 is not intended to limit or otherwise confine the embodiments described and contemplated herein to any particular configuration nor is it intended to exclude any alternative configuration that can be used in connection with embodiments of the present disclosure. It will be understood that while many of the aspects and components presented in FIG. 1 are shown as discrete, separate elements, other configurations may be used in connection with the methods, apparatuses, and systems described herein, including configurations that combine, omit, separate, and/or add aspects and/or components.

According to various embodiments, the power source 102 is configured to provide a single-phase power and comprises a powered conductor line and a return line connected to ground. According to some other embodiments, the power source 102 may be configured to provide a three-phase power, a split phase power, and/or the like. In an example embodiment, the power source 102 is configured to supply power to a telecommunications power distribution system for delivering power to telecommunications electrical equipment such as, but not limited to, 5G cell tower radios. In such example embodiment, the power source 102 may be configured to provide a −48V direct current (e.g., −48 VDC) power.

Ground equipment utilized in telecommunications often comprise alternating current (AC) to direct current (DC) power converters (AC-DC power converters) housed in an electrical cabinet. According to various embodiments, the AC-DC power converters may be electrically connected to the protection module 104. Further, in some embodiments, the protection module 104 (or a portion thereof) may be configured such that it may be located in the electrical cabinet or in an outside enclosure mounted proximate to, or otherwise near, the base of the cell tower. The electrical cabinet may be located at the base of the cell tower. According to various embodiments, the power source 102 is coupled to or otherwise includes at least one power source circuit breaker 120 configured to interrupt power supplied to electrical equipment and/or power distribution systems when triggered (e.g., tripped). In some embodiments, the power source circuit breaker 120 may be upstream relative to the cell tower. Alternatively or additionally, the power source circuit breaker 120 may be located within the electrical cabinet.

The protection module 104 comprises an overvoltage protection circuitry 106 and/or a device failure protection circuitry 108 in electrical communication with the overvoltage protection circuitry (e.g., electrically connected to the overvoltage protection circuitry 106). According to various embodiments, the overvoltage protection circuitry 106 is configured to protect electrical equipment from overvoltage condition arising in the power source 102 (e.g., voltage surge due to lighting strike, or the like). As further described below, the protection module 104 may be configured for protecting each of one or more overvoltage modes (e.g., defined by the powered conductor lines, return line, and ground of the power source 102).

The overvoltage protection circuitry 106 includes one or more overvoltage protection components 112, such as varistor(s), configured for protecting against overvoltage condition. In various embodiments, at least a portion of the one or more overvoltage protection components 112 is connected between a powered conductor line (e.g., −48 VDC in an example telecommunications implementation) and a return line of the power source 102. Alternatively or additionally, in various embodiments, at least a portion of the one or more overvoltage protection components 112 is connected between the return line and the ground of the power source 102. The one or more overvoltage protection components 112 may be configured to form a low resistance path for overvoltage current when an overvoltage condition is present in the power source 102. In this regard, by forming the low resistance path for the overvoltage current, the one or more overvoltage protection components 112 protect the electrical equipment from overvoltage condition in the power source 102.

The device failure protection circuitry 108 includes a thermal sensitive component 114 in thermal communication with the one or more overvoltage protection components 112. The device failure protection circuitry 108 further includes a circuit breaker trigger component 116 in electrical communication with the thermal sensitive component (e.g., electrically connected to the thermal sensitive component 114). The circuit breaker trigger component 116 may comprise any device capable of triggering/tripping a circuit breaker. In some example embodiments, the thermal sensitive component 114 may be configured to perform the function of the circuit breaker trigger component 116 such that the circuit breaker trigger component 116 is not needed. In various embodiments, the thermal sensitive component 114 comprises, corresponds to, and/or functions as a normally open temperature switch configured to close (e.g., change from the normally open state to a closed state) when it senses or is otherwise exposed to temperature above a threshold temperature. According to various embodiments, the threshold temperature may be selected such that it is less than the maximum normal operating temperature of the components of the overvoltage protection system 100.

In various embodiments, the temperature sensed by the thermal sensitive component 114 corresponds to the heat conducted by an overvoltage protection component 112 to the thermal sensitive component 114 when the overvoltage protection component fails (e.g., at its end of life). In this regard, the thermal sensitive component 114 may be configured to switch from an open state to a closed state in response to sensing a temperature that satisfies (e.g., exceeds, is equal to, or the like) a threshold temperature. In some embodiments, the thermal sensitive component 114 comprise a thermal switch (described further below). In some embodiments, the thermal sensitive comprise a thermal sensor assembly (described further below).

The thermal sensitive component 114 may be configured to cause the circuit breaker trigger component 116 to be in a shorting position with respect to the power source 102 (e.g., powered conductor line thereof). For example, the thermal sensitive component 114 may be configured to cause the circuit breaker trigger component 116 to create a short circuit. The shorting position (e.g., short circuit), in turn, causes the power source circuit breaker 120 to trip and interrupt the power supplied by the power source 102 to electrical equipment and/or power distribution system being supplied power by the power source 102. In various embodiments, the circuit breaker trigger component 116 comprise an electromechanical switch (or electromechanical actuator) such as a latching relay. It will be appreciated that the circuit breaker trigger component 116 may be any suitable element or device capable of triggering a power source circuit breaker 120. In some example embodiments, the thermal sensitive component 114 may be configured to directly cause the power source circuit breaker 120 to trip and interrupt the power supplied by the power source 102 to electrical equipment and/or power distribution system being supplied power by the power source 102. In such example embodiments, the device failure protection circuitry 108 may not include a separate circuit breaker trigger component 116.

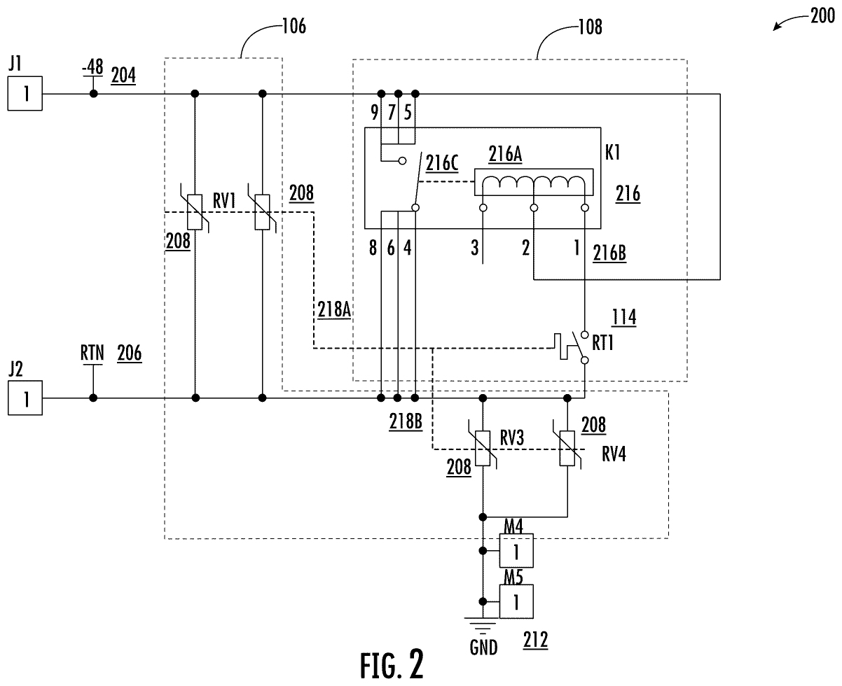

FIG. 2 shows a schematic diagram of an overvoltage protection apparatus 200 in accordance with at least one embodiment of the present disclosure. Specifically, FIG. 2 shows a at least a portion of a circuit diagram of an overvoltage protection apparatus 200 in accordance with at least one embodiment of the present disclosure. For example, one or more of the power source 102, overvoltage protection circuitry 106, device failure protection circuitry 108, or output power 110 may be embodied by one or more apparatuses 200. In this regard, in some embodiments, the overvoltage protection system 100 or one or more portions thereof, if embodied in a particular embodiment, may be embodied by one or more apparatuses 200. The overvoltage protection apparatus 200 may be configured to function at least in part as a surge protection device.

According to various embodiments, the overvoltage protection apparatus 200 is configured for protecting electrical equipment against an overvoltage condition in a power source for supplying power to electrical equipment or power distribution system for delivering power to electrical equipment, and also protecting against a failure condition associated with the overvoltage protection apparatus 200. According to various embodiments, the overvoltage protection apparatus 200 includes one or more overvoltage protection components, and the failure condition includes failure of at least one of the one or more overvoltage protection components at the end of life of the overvoltage protection component.

In various embodiments, each of the one or more overvoltage protection components comprise a varistor. Specifically, in various embodiments, each of the one or more overvoltage protection components comprises a metal-oxide varistor. It would be appreciated that in some other embodiments, the overvoltage protection component may be any suitable device capable of protecting electrical equipment from an overvoltage condition.

The overvoltage protection apparatus 200 includes an overvoltage protection circuitry such as the overvoltage protection circuitry 106 described above with respect to FIG. 1. In various embodiments, the overvoltage protection circuitry 106 of the apparatus 200 includes a set of one or more varistors 208 connected between a powered conductor line 204 and a return line 206. In example embodiments where the set of one or more varistors 208 between the powered conductor line 204 and the return line 206 comprise more than one varistor 208, such as the example embodiment illustrated in FIG. 2, the varistors 208 may be connected in parallel relative to one another. In an example embodiment, the powered conductor line 204 is a −48 VDC line configured for supplying power to electrical equipment such as, but not limited to, telecommunications electrical equipment (e.g., 5G cell tower radio or the like) and/or supplying power to telecommunications power distribution system for delivering power to telecommunications electrical equipment.

The path between the powered conductor line 204 and the return line 206 may define a first overvoltage mode (e.g., a circuit path that could experience overvoltage). In this regard, the set of one or more varistors 208 between the powered conductor line 204 and the return line 206 may represent a mode of protection between the powered conductor line 204 and the return line 206 (e.g., powered conductor-to-return mode of protection). For example, the set of one or more varistors 208 between the powered conductor line 204 and the return line 206 may be configured to protect against overvoltage condition that occurs between the powered conductor line 204 and the return line 206.

Alternatively or additionally, and as illustrated in FIG. 2, the overvoltage protection apparatus 200 includes a set of one or more varistors 208 connected between the return line 206 and ground 212. In example embodiments where the set of one or more varistors 208 between the return line 206 and the ground 212 comprise more than one varistor 208, such as the example embodiment illustrated in FIG. 2, the varistors 208 may be connected in parallel relative to one another.

The path between the return line 206 and the ground 212 may define a second overvoltage mode (e.g., another circuit path that could experience overvoltage). In this regard, the set of one or more varistors between the return line 206 and the ground 212 may represent a mode of protection between the return line 206 and the ground 212 (e.g., return-to-ground mode of protection). For example, the set of one or more varistors 208 between the return line 206 and the ground 212 may be configured to protect against overvoltage condition that occurs between the return line 206 and the ground 212.

Further, the path between the powered conductor line 204 and the ground 212 may define a third overvoltage mode (e.g., another circuit path that could experience overvoltage). In this regard, the set of one or more varistors 208 between the powered conductor line 204 and the return line 206 and the set of one or more varistors 208 between the return line 206 and the ground 212 may collectively represent a mode of protection between the powered conductor line 204 and the ground 212 (e.g., powered conductor-ground mode of protection or powered conductor-return-ground mode of protection).

In this regard, the overvoltage protection apparatus 200 may include a first mode of protection between the powered conductor line 204 and the return line 206, a second mode of protection between the return line 206 and the ground 212, and/or a third mode of protection between the powered conductor line 204 and the ground 212. It would be appreciated that in some other embodiments, the apparatus 200 may not include one or more of the first mode of protection, the second mode of protection, or the third mode of protection.

The overvoltage protection apparatus 200 includes a device failure protection circuitry such as the device failure protection circuitry 108 described with respect to FIG. 1. The device failure protection circuitry 108 of the apparatus 200 may comprise a thermal sensitive component 114. The thermal sensitive component 114 may be thermally coupled to the first set of one or more varistors 208 and/or thermally coupled to the second set of one or more varistors 208 (e.g., in in thermal communication with both the first set of one or more varistors 208 and the second set of one or more varistors 208). The thermal sensitive component 114 may comprise and/or function as a normally open temperature switch configured to close (e.g., change from a normally open state to a closed state) when it senses temperature or is otherwise exposed to temperature above a threshold temperature. According to various embodiments, the threshold temperature is selected such that it is less than the maximum normal operating temperature of the components of the apparatus 200. In one example embodiment, the thermal sensitive component 114 may be configured to change from a normally open state to a permanently closed state when it senses temperature or is otherwise exposed to temperature above a threshold temperature.

Generally, when a varistor, such as varistor 208, fails or otherwise reaches its end of life, the varistor voltage (e.g., voltage across the varistor) drops and the leakage current increases. This increase in leakage current causes the varistor 208 to generate and conduct heat to the thermal sensitive component 114. The dashed lines 218A depicted in FIG. 2 represent thermal conductivity (e.g., heat transfer) between the first set of one or more varistors 208 and the thermal sensitive component 114. The dashed lines 218B depicted in FIG. 2 represent thermal conductivity between the second set of one or more varistors 208 and the thermal sensitive component 114. As the leakage current increases, the heat generated and conducted by the varistor 208 may increase and pose risk of severe damage to components of the apparatus 200. For example, the varistor 208 may go into thermal runaway.

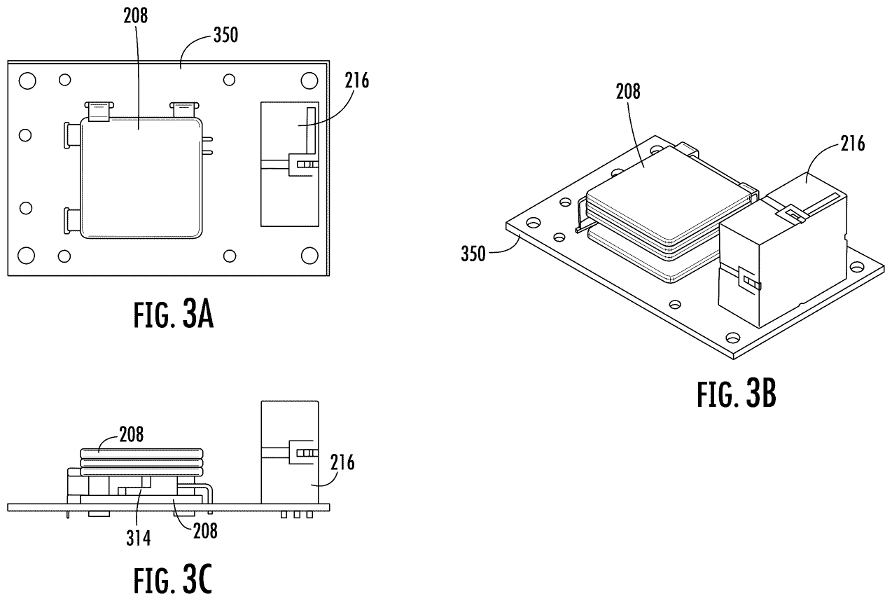

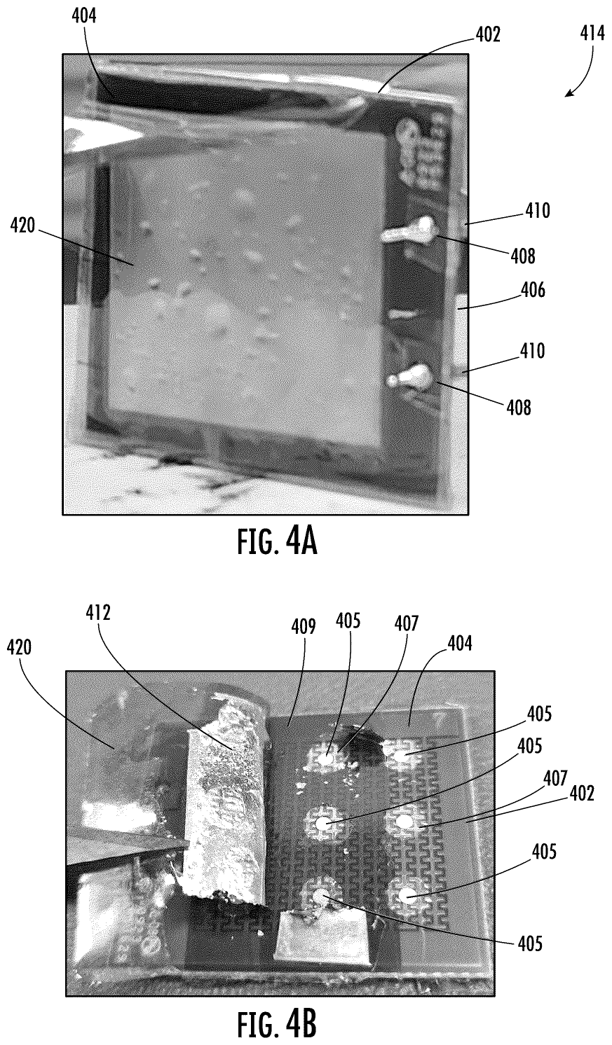

In some embodiments, as further described below with respect to FIGS. 3A-C, the thermal sensitive component 114 comprises a thermal switch 314. In some embodiments, as further described below with respect to FIGS. 4A-B, the thermal sensitive component 114 comprises a thermal sensor assembly 414.

The device failure protection circuitry 108 of the overvoltage protection apparatus 200 includes a circuit breaker trigger component 116. In various embodiments, the circuit breaker trigger component 116 comprises an electromechanical switch (or electromechanical actuator), such as a latching relay 216. The latching relay 216 may comprise coils 216A, a set of input terminals 216B, and/or a set of operating contact terminals 216C. The latching relay 216, for example, may comprise any number of terminals. For example, the latching relay 216, may be a two-pin relay, a three-pin relay, a five-pin relay, or the like. The latching relay 216 may be configured to maintain its contact position without continuous power application (e.g., without power being applied to the coils 216A). According to various embodiments, the latching relay 216 is a normally open latching relay. It would be appreciated that in some other embodiments, the latching relay 216 may comprise other configuration.

Still referencing FIG. 2, the latching relay 216 is connected to the thermal sensitive component 114 (e.g., via the coils 216A of the latching relay 216). The thermal sensitive component 114 is configured to energize the coils 216A of the latching relay 216 when the thermal sensitive component 114 senses or is otherwise exposed to a temperature that satisfies a threshold temperature. In this regard, when any of the varistors 208 conduct heat (e.g., due to end of life or other failure), to the thermal sensitive component 114 that causes the thermal sensitive component 114 to experience a temperature that satisfies the threshold temperature, the thermal sensitive component 114 may switch from an open state to a close state and actuate the latching relay to a shorting position (e.g., energize the coils 216A of the latching relay 216 to a shorting position). For example, the contact terminals 216C of the latching relay may switch to a closing state (e.g., come in contact) in response to the thermal sensitive component switching from an open state to a closed state when it is exposed to a temperature that exceeds or otherwise satisfies the threshold temperature. According to various embodiments, the shorting position of the latching relay (e.g., short circuit created by the latching relay) triggers the power source circuit breaker coupled to the powered conductor line 204 to interrupt the power supplied to electrical equipment and/or power distribution system being supplied power by the powered conductor line 204. As described above, an example of such power distribution system is a telecommunications power distribution system.

In this regard, according to various embodiments, when the thermal sensitive component 114 closes in response to sensing a temperature that satisfies the threshold temperature, the thermal sensitive component 114 energizes the coils 216A of the latching relay 216 to close across the powered conductor line 204 and the return line 206 such that the latching relay is in a shorting position with respect to the powered conductor line 204 (e.g., creates a short circuit). The shorting position of the latching relay (e.g., short circuit), in turn, triggers the power source circuit breaker coupled to the powered conductor line 204 which causes power supplied by the powered conductor line 204 to be interrupted.

In some example embodiments, device failure protection circuitry 108 may not include circuit breaker trigger component 116. In such example embodiments, when any of the varistors 208 conduct heat (e.g., due to end of life or other failure) to the thermal sensitive component 114 that causes the thermal sensitive component 114 to experience a temperature that satisfies the threshold temperature, the thermal sensitive component 114 may switch from an open state to a close state and trigger the power source circuit breaker coupled to the powered conductor line 204 to interrupt the power supplied to electrical equipment and/or power distribution system being supplied power by the powered conductor line 204. According to various embodiments, the first set of one or more overvoltage protection components 112, the second set of one or more overvoltage protection components 112, the thermal sensitive component 114 (e.g., thermal switch 314 or thermal sensor assembly 414), and/or the latching relay 216 may be housed in a protector housing (e.g., configured to protect the components from environmental conditions).

FIGS. 3A-C show at least a portion of an operational example of an overvoltage protection apparatus 200 in accordance with at least one embodiment of the present disclosure. Specifically, FIG. 3A shows a top view of an operational example of the overvoltage protection apparatus 200. FIG. 3B shows a perspective view of an operational example of the overvoltage protection apparatus 200. FIG. 3C shows a side view of an operational example of the overvoltage protection apparatus 200.

In the illustrated embodiment of FIGS. 3A-C, the thermal sensitive component 114 comprises a thermal switch 314 (e.g., a thermostat, or the like). The thermal switch 314 is thermally connected to the first set of one or more varistors 208 and/or thermally connected to the second set of one or more varistors 208. In the illustrated embodiment of FIGS. 3A-C, the thermal switch 314 is configured to function as a normally open temperature switch configured to close (e.g., switch from a normally open state to a closed state) in response to sensing a temperature that satisfies a threshold temperature. In this regard, when the heat conducted from a varistor 208 (e.g., due to failure and/or otherwise end of life of the varistor 208) to the thermal switch 314 causes the temperature to rise such that it satisfies (e.g., exceeds, is equal to, or the like) the threshold temperature, the thermal switch 314 will switch from its normally open state to a closed state in response to the temperature.

When the thermal switch 314 closes, or is otherwise activated, in response to sensing a temperature that satisfies the threshold temperature, it energizes the coils 216A of the latching relay 216 (e.g., actuates the latching relay 216) to close across the powered conductor line 204 and the return line 206 such that the latching relay is in a shorting position. Further, the shorting position of the latching relay may be configured to cause the power source circuit breaker to trip and interrupt power supplied by the powered conductor line to the electrical distribution system.

As shown in FIGS. 3A-C, one or more components of the overvoltage protection apparatus 200 may be mounted and/or disposed on a circuit board 350. In the illustrated embodiment shown in FIGS. 3A-C, the first set of varistors 208 and the second set of varistors 208 of the overvoltage protection apparatus 200 are mounted and/or disposed on the circuit board 350. For example, the varistors 208 may be stacked relative to one another. In the illustrated embodiment of FIGS. 3A-C, the thermal switch 314 and the latching relay 216 are also mounted and/or disposed on the circuit board 350. In some embodiments, the circuit board 350 is a rigid circuit board. In some embodiments, the circuit board 350 is a flexible circuit board.

As described above, in some embodiments, the thermal sensitive component 114 of the device failure protection circuitry comprises a thermal sensor assembly 414. FIG. 4A shows an operational example of a thermal sensor assembly 414 in accordance with at least one embodiment of the present disclosure. FIG. 4B shows an operational example of a thermal sensor assembly 414 showing various components thereof in accordance with at least one embodiment of the present disclosure. The thermal sensor assembly 414 comprises a circuit board 402 having a first side 404 (e.g., a top side) and a second side 406 (e.g., a bottom side). In various embodiments, the circuit board 402 is a thin circuit board (e.g., a thin printed circuit board). In some embodiments, the circuit board 402 comprises a rigid material. For example, the circuit board 402 may be a rigid circuit board. In some embodiments, the circuit board 402 comprises a flexible material. For example, the circuit board 402 may be a flexible circuit board.

The thermal sensor assembly 414 includes at least a pair of electrodes 405 formed and/or disposed on the circuit board 402. In some embodiments, each of the first side 404 and second side 406 of the circuit board 402 comprises at least a pair of electrodes 405. According to various embodiments, the pair of electrodes 405 are spaced apart and proximate to each other on each of the first side 404 and/or the second side 406 of the circuit board 402. For example, the pair of electrodes 405 may define a gap therebetween. The electrodes 405 may be formed from and/or comprise any suitable material. In an example embodiment, the electrodes 405 comprise bare copper.

In some embodiments, a solder mask 407 defining one or more openings therethrough is disposed on at least a portion of the circuit board 402 comprising the electrodes 405. For example, a solder mask may be disposed on the first side 404 of the circuit board 402. Additionally, in some embodiments, a solder mask may be disposed on the second side 406 of the circuit board. According to various embodiments, an insulator 409 (e.g., layer of insulator) defining one or more openings therethrough is disposed over the electrodes 405 and/or the solder mask (e.g., in embodiments comprising solder masks). For example, an insulator 409 may be disposed on the first side 404 of the circuit board 402. Additionally, an insulator 409 may be disposed on the second side 406 of the circuit board 402. The insulator 409 may be formed from or otherwise comprise any suitable insulator material. In an example embodiment, the insulator 409 comprises polyimide material.

A meltable component 412 is disposed on the insulator 409 (e.g., on the first side 404 of the circuit board 402 and/or on the second side 406 of the circuit board 402). In this regard, the insulator 409 may be configured to insulate the meltable component 412 from the electrodes 405 (e.g., at least during normal operation). In various embodiments, the meltable component 412 comprise a low temperature melting alloy such as solder. Specifically, in some embodiments, the meltable component 412 comprises a layer of ribbon solder disposed over the electrodes 405 with an insulator 409 disposed between the meltable component (e.g., layer of ribbon solder, or the like) and the electrodes 405.

In various embodiments, another insulator 420 (e.g., a second layer of insulator 420 is disposed over the meltable component 412. The second layer of insulator 420 may be configured to insulate the meltable component 412 from other components on the circuit board 402. The second insulator 420 may be formed from or otherwise comprise any suitable insulator material. In an example embodiment, the second insulator 420 comprises polyimide material.

The circuit board 402 further comprises two normally open contacts 408 (e.g., a pair of normally open contacts 408) with each normally open contacts 408, each having a wire 410 attached thereto. The wires 410 may be configured for being coupled to the latching relay 216 and/or in electrical communication with the latching relay 216. According to various embodiments, the normally open contacts 408 are configured for actuating the latching relay 216 when the thermal sensor assembly 414 (e.g., meltable component 412 thereof) is exposed to a temperature that satisfies (e.g., exceeds, is equal to, or the like) the threshold temperature. In this regard, the thermal sensor assembly 414 may be configured to actuate the latching relay 216 to trigger (e.g., trip) the power source circuit breaker coupled to the powered conductor line 204 when an overvoltage protection component, such as a varistor 208, is at its end of life or otherwise fails.

As described above, when an overvoltage protection component, such as a varistor 208, is at its end of life or otherwise fails, it generates heat. This heat is conducted to the meltable component 412, which causes the meltable component 412 to melt when the temperature (e.g., due to the heat) reaches the melting temperature of the meltable component 412 and to complete the circuit to actuate the latching relay 216 (e.g., energize the coils of the latching relay 216). For example, the meltable component 412 may be configured to melt and flow across the pair of electrodes to form a current flow path between the pair of electrodes to actuate the latching relay when the meltable component 412 is exposed to a temperature that exceeds the threshold temperature, wherein the threshold temperature may be about the same as the melting temperature of the meltable component 412.

In this regard, according to various embodiments, a meltable component having a melting temperature that is about the same as the threshold temperature may be selected as the meltable component 412. In some embodiments, the threshold temperature is less than 125° C. In an example embodiment, the meltable component 412 has a melting temperature in a range of 120-125° C. It would be appreciated that in on other embodiments, the melting temperature of the meltable component 412 may be less than 120° C. or greater than 125° C.

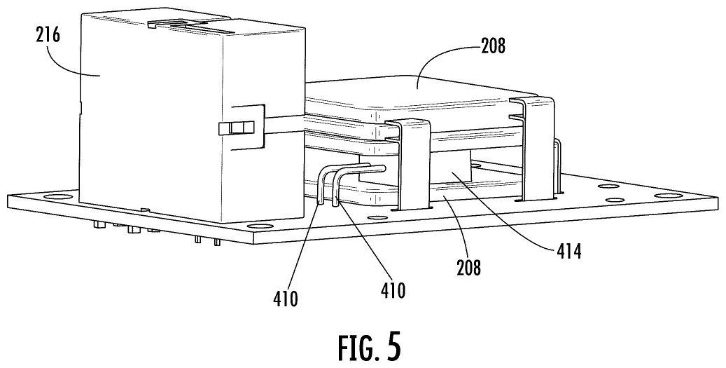

FIG. 5 shows an operational example of an overvoltage protection apparatus showing a thermal sensor assembly 414 thereof. In the illustrated embodiment of FIG. 5, the thermal sensor assembly 414 is positioned between a stack of varistors 208. When a varistor 208 of the stack of varistors 208 is at its end of life or otherwise fails, it conducts heat to the thermal sensor assembly 414 (and thus towards the meltable component 412 therein). When the temperature due to the heat reaches the threshold temperature (e.g., melting temperature of the meltable component), the meltable component 412 melts and completes the circuit to energize the latching relay 216, as described above.

In various embodiments, the thermal sensor assembly 414 is a thin thermal sensor assembly (e.g., comprising a thin circuit board 402, thin flat varistors 208, and a thin meltable component 412). In this regard, the varistor(s) 208 above the thermal sensor assembly 414 as well as the varistor(s) 208 below the thermal sensor assembly 414 are positioned in close proximity to the thermal sensor assembly 414, which, advantageously, allows the thermal sensor assembly 414 to react quickly when any of the varistors 208 is at its end of life. Specifically, when any of the varistors 208 is at its end of life, heat generated by the respective varistor 208 is quickly conducted to the thermal sensor assembly 414 based on the close proximity of the varistor 208 to the thermal sensor assembly 414 (hence, the meltable component 412 thereof). This, in turn, causes the thermal sensor assembly 414 to be substantially in lock step with the varistors 208 with respect to the heat generated by the varistors 208, such that the meltable component 412 is exposed to a temperature that corresponds to the heat generated by the varistor in real-time or near real-time. For example, the heat generated by a varistor 208 is quickly conducted to the meltable component 412 at least because of the close proximity of the thermal sensor assembly 414 to the varistors 208 due to the thin configuration thereof.

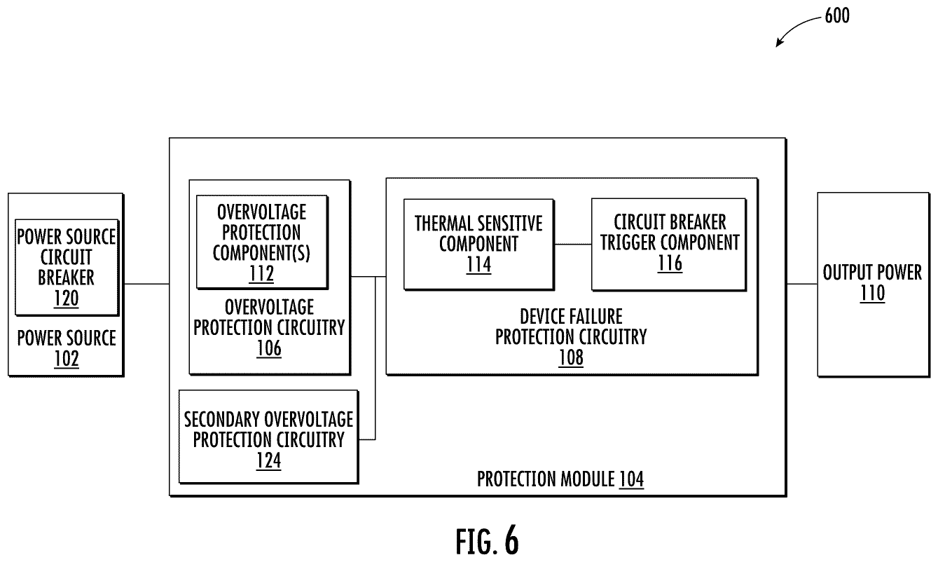

FIG. 6 shows a schematic diagram of an overvoltage protection system 600 in accordance with at least one embodiment of the present disclosure. The overvoltage protection system 600 may be configured to function as a surge protector. In the illustrated embodiment of FIG. 6, the overvoltage protection system 600 includes a power source 102, a protection module 104, and an output power 110. The depiction of the overvoltage protection system 100 is not intended to limit or otherwise confine the embodiments described and contemplated herein to any particular configuration nor is it intended to exclude any alternative configuration that can be used in connection with embodiments of the present disclosure. It will be understood that while many of the aspects and components presented in FIG. 6 are shown as discrete, separate elements, other configurations may be used in connection with the methods, apparatuses, and systems described herein, including configurations that combine, omit, separate, and/or add aspects and/or components.

As shown in FIG. 6, one or more of the components (e.g., power source 102, overvoltage protection circuitry 106, device failure protection circuitry 108, and output power 110) of the overvoltage protection system 600 are the same as those of the overvoltage protection system 100 of FIG. 1 and have been described above. For brevity, detailed description of these components will not be repeated.

The protection module 104 comprises an overvoltage protection circuitry 106, a secondary overvoltage protection circuitry 124, and/or a device failure protection circuitry 108. According to various embodiments, one or more of the overvoltage protection circuitry 106, secondary overvoltage protection circuitry 124, and device failure protection circuitry 108 are electrically connected together. According to various embodiments, the overvoltage protection circuitry 106 is the primary overvoltage protection circuitry and is configured to protect electrical equipment from overvoltage condition (e.g., excess voltage) in the power source 102. According to various embodiments, the secondary overvoltage protection circuitry 124 may be leveraged to protect individual electrical equipment and/or electronics (e.g., televisions, cell tower radio, or the like) in residential buildings, commercial buildings, telecommunications, or the like from overvoltage condition. The secondary overvoltage protection circuitry 124 includes an inductor and a diode configured to collectively protect against overvoltage condition.

The device failure protection circuitry 108 includes a thermal sensitive component 114 in thermal communication with the one or more overvoltage protection components 112. The device failure protection circuitry 108 further includes a circuit breaker trigger component 116 electrically connected to the thermal sensitive component 114. In various embodiments, the thermal sensitive component 114 is configured to sense temperature corresponding to heat conducted by an overvoltage protection component (e.g., when the overvoltage protection component fails or is otherwise at its end of life). According to various embodiments, the thermal sensitive component 114 is configured to switch from an open state to a closed state in response to sensing a temperature that satisfies (e.g., exceeds, is equal to, or the like) the threshold temperature. According to various embodiments, the threshold temperature is selected such that it is less than the maximum normal operating temperature of certain components of the overvoltage protection system 600. In some embodiments, the thermal sensitive component 114 is a thermal switch (e.g., normally open thermal switch). In some embodiments, the thermal sensitive component 114 is a thermal sensor assembly.

The thermal sensitive component 114 may be configured to cause the circuit breaker trigger component 116 to be in a shorting position which, in turn, triggers the power source circuit breaker 120 to cause interruption in the power supply from the power source 102 to the electrical equipment.

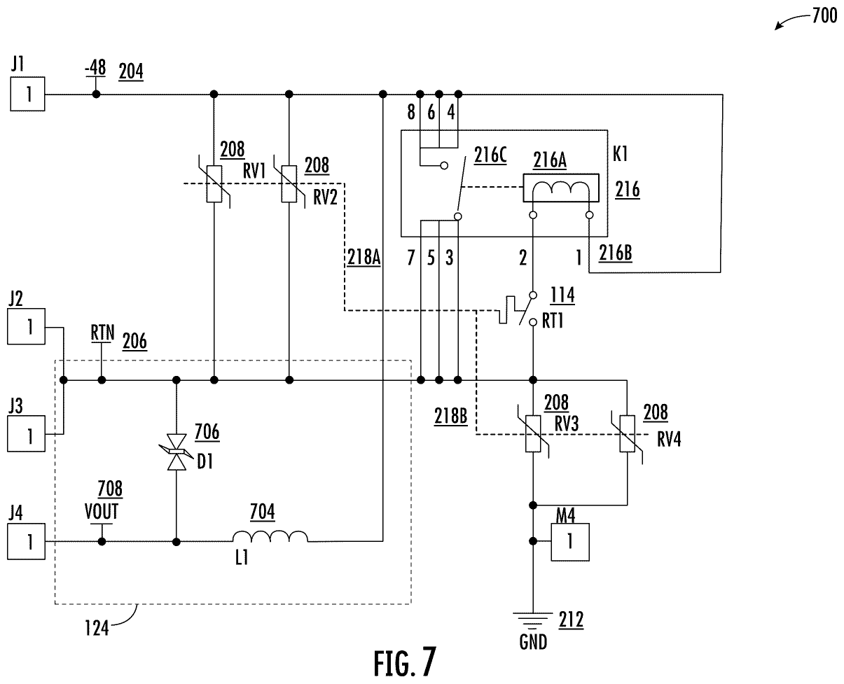

FIG. 7 shows a schematic diagram of an overvoltage protection apparatus 700 in accordance with at least one embodiment of the present disclosure. Specifically, FIG. 7 shows at least a portion of a circuit diagram of an overvoltage protection apparatus 700 in accordance with at least one embodiment of the present disclosure. For example, one or more of the power source 102, overvoltage protection circuitry 106, secondary overvoltage protection circuitry 124, device failure protection circuitry 108, or output power 110 may be embodied by one or more apparatuses 700. In this regard, in some embodiments, the overvoltage protection system 600 or one or more portions thereof, if embodied in a particular embodiment, may be embodied by one or more apparatuses 700. The overvoltage protection apparatus 700 may be configured to function at least in part as a surge protection device.

According to various embodiments, the overvoltage protection apparatus 700 is configured for protecting electrical equipment against an overvoltage condition in a power system for delivering power to the electrical equipment and also protecting against a failure condition associated with the overvoltage protection apparatus 700. The overvoltage protection apparatus 700 includes one or more overvoltage protection components, and the failure condition may occur at the end of life of any of the one or more overvoltage protection components.

The overvoltage protection apparatus 700 includes an overvoltage protection circuitry comprising a set of one or more varistors 208 connected in parallel and between a powered conductor line 204 and a return line 206 in a power system. Alternatively or additionally, the overvoltage protection apparatus 700 includes a set of one or more varistors 208 connected in parallel and between the return line 206 and ground 212 in the power system. As shown in FIG. 7, the overvoltage protection apparatus 700 further includes a device failure protection circuitry comprising a thermal sensitive component 114. The thermal sensitive component 114 is thermally coupled to the first set of one or more varistors 208 and/or thermally coupled to the second set of one or more varistors 208. In some embodiments, the thermal sensitive component 114 comprise a thermal switch 314. In some embodiments, the thermal sensitive component 114 comprise a thermal sensor assembly 414. The device failure protection circuitry of the overvoltage protection apparatus 700 further includes circuit breaker trigger component 116. The circuit breaker trigger component 116 may comprise an electromechanical switch (or electromechanical actuator), such as a latching relay 216.

As shown in FIG. 7, one or more of the components (e.g., overvoltage protection circuitry comprising sets of one or more varistors 208 and device failure protection circuitry comprising a thermal sensitive component 114 and circuit breaker trigger component 116) of the overvoltage protection apparatus 700 are the same as those of the overvoltage protection apparatus 200 of FIG. 2 and have been described above. For brevity, detailed description of these components will not be repeated.

The overvoltage protection apparatus 700 includes a secondary overvoltage protection circuitry such as the secondary overvoltage protection circuitry 124. The secondary overvoltage protection circuitry includes an inductor 704 and a diode 706, such as a bidirectional Zener diode. In some embodiments, the diode 706 may be a TVS diode or other suitable diode. The diode 706 is connected in between the return line 206 and the output 708 and connected with the inductor 704. In various embodiments, the secondary overvoltage protection circuitry 124 is configured for protecting individual electric equipment. For example, the secondary overvoltage protection circuitry may be leveraged to protect electronics (e.g. televisions, or the like) in residential buildings, commercial buildings, or the like. As another example, the secondary overvoltage protection circuitry may be leveraged to protect cell tower radio utilized in telecommunications.

In various embodiments, the overvoltage protection apparatus (e.g., overvoltage protection apparatus 200 or overvoltage protection apparatus 700) or at least a portion thereof may be embodied in a housing. For example, the overvoltage protection apparatus 200 may include a protector housing configured to house one or more of the overvoltage protection component(s), the thermal sensitive component 114 (e.g., thermal switch, electromechanical switch, or the like), the circuit breaker trigger component, and/or other components of the overvoltage protection apparatus.

In some embodiments, the overvoltage protection apparatus may comprise one or more user interface components such as LCD screens, LED indicator lights, and/or the like. In an example embodiment, one or more user interface components indicate various functions of the overvoltage protection apparatus, such as power on, surge detected, and end of life failure condition (e.g., EOL Failure). For example, the user interface components may be configured to indicate to a user that an overvoltage condition is present. Alternatively or additionally, the user interface components may be configured to indicate to a user that an overvoltage protection component has failed or otherwise reached its end of life.

In some embodiments, the power source 102 comprises a plug configured to plug into a −48 VDC power supply such as a −48 VDC telecommunications power supply. Furthermore, in some embodiments, output power 110 comprises a plug configured to accept a 48 VDC rated plug from a telecommunications power distribution system.

Moreover, many modification and other embodiments of the invention set forth herein will come to mind to one skilled in the art to which these inventions pertain having the benefit of the teaching presented in the foregoing descriptions and the associated drawings. Therefore, it is to be understood that the inventions are not to be limited to the specific embodiments disclosed and that modifications and other embodiments are intended to be included within the scope of the application.

1. An overvoltage protection apparatus with failure protection comprising:
a first set of one or more overvoltage protection components connected between a powered line and a return line, wherein at least one overvoltage protection component of the first set of one or more overvoltage protection components generates heat when at its end of life;
a thermal switch in thermal communication with the first set of one or more overvoltage protection components; and
a electromechanical switch coupled to the thermal switch and configured to trigger a circuit breaker for the powered line when actuated, wherein when the thermal switch is exposed to a temperature corresponding to the heat generated by the at least one overvoltage protection component and the temperature exceeds a threshold temperature, the thermal switch actuates the electromechanical switch to create a short circuit such that the short circuit triggers the circuit breaker to interrupt power supplied by the powered line.

2. The overvoltage protection apparatus of claim 1, wherein the electromechanical switch comprises a latching relay.

3. The overvoltage protection apparatus of claim 1, wherein the thermal switch is a normally open thermal switch configured to switch to a closed state when exposed to temperature that exceeds the threshold temperature.

4. The overvoltage protection apparatus of claim 1, wherein the threshold temperature is less than 125° C.

5. The overvoltage protection apparatus of claim 1, wherein the powered line and the return line are connected to a telecommunications power distribution system configured to supply power to electrical equipment including telecommunications electrical equipment located at a cell tower.

6. The overvoltage protection apparatus of claim 5, wherein the circuit breaker is upstream relative to the cell tower.

7. The overvoltage protection apparatus of claim 1, further comprising a second set of one or more overvoltage protection components connected between the return line and a ground, wherein the thermal switch is further in thermal communication with the second set of one or more overvoltage protection components.

8. The overvoltage protection apparatus of claim 7, wherein the first set of one or more overvoltage protection components comprise a first set of one or more varistors and the second set of one or more overvoltage protection components comprise a second set of one or more varistors.

9. The overvoltage protection apparatus of claim 7, wherein the thermal switch is exposed to a temperature that exceeds the threshold temperature when an overvoltage protection component of any of the first set of one or more overvoltage protection components or any of the second set of one or more overvoltage protection components fails at its end of life and generates heat corresponding to a temperature that exceeds the threshold temperature.

10. The overvoltage protection apparatus of claim 7, wherein the first set of one or more overvoltage protection components, the second set of one or more overvoltage protection components, the thermal switch, and the electromechanical switch are formed and/or disposed on a circuit board.

11. The overvoltage protection apparatus of claim 7, further comprising a protector housing configured to house one or more of (i) the first set of one or more overvoltage protection components, (ii) the second set of one or more overvoltage protection components, (iii) the thermal switch, or (iv) the electromechanical switch.

12. An overvoltage protection apparatus with failure protection comprising:
a first set of one or more overvoltage protection components connected between a powered line and a return line, wherein at least one overvoltage protection component of the first set of one or more overvoltage protection components generates heat when at its end of life;
a thermal sensor assembly in thermal communication with the first set of one or more overvoltage protection components; and
a electromechanical switch coupled to the thermal sensor assembly and configured to trigger a circuit breaker for the powered line when actuated, wherein when the thermal sensor assembly is exposed to a temperature corresponding to the heat generated by the at least one overvoltage protection component and the temperature exceeds a threshold temperature, the thermal sensor assembly actuates the electromechanical switch to create a short circuit such that the short circuit triggers the circuit breaker to interrupt power supplied by the powered line.

13. The overvoltage protection apparatus of claim 12, wherein the electromechanical switch comprises a latching relay.

14. The overvoltage protection apparatus of claim 12, wherein the thermal sensor assembly comprises a circuit board having at least a pair of electrodes and a meltable component disposed thereon, and wherein the meltable component is configured to melt and flow across the pair of electrodes to form a current flow path between the pair of electrodes when the meltable component is exposed to a temperature that exceeds the threshold temperature.

15. The overvoltage protection apparatus of claim 14, wherein the circuit board further comprises two normally open contacts, wherein the current flow path between the pair of electrodes causes the two normally open contacts to close to actuate the electromechanical switch.

16. The overvoltage protection apparatus of claim 14, wherein the meltable component comprises a low temperature melting alloy.

17. The overvoltage protection apparatus of claim 14, wherein the meltable component is disposed over the pair of electrodes with an insulator disposed between the meltable component and the pair of electrodes.

18. The overvoltage protection apparatus of claim 14, further comprising a second set of one or more overvoltage protection components connected between the return line and a ground, wherein the thermal sensor assembly is further in thermal communication with the second set of one or more overvoltage protection components.

19. The overvoltage protection apparatus of claim 18, wherein the first set of one or more overvoltage protection components comprise a first set of one or more varistors and the second set of one or more overvoltage protection components comprise a second set of one or more varistors.

20. The overvoltage protection apparatus of claim 18, wherein the meltable component is exposed to a temperature that exceeds the threshold temperature when an overvoltage protection component of any of the first set of one or more overvoltage protection components or any of the second set of one or more overvoltage protection components fails at its end of life and generates heat corresponding to a temperature that exceeds the threshold temperature.
